(19) United States
(12) Patent Application Publication
(10) Pub. No.: US 2026/0213326 A1
(43) Pub. Date: Jul. 23, 2026

(54) ELECTRICAL DEVICE AND BATTERY PACK

(71) Applicant: Nanjing Chervon Industry Co., Ltd., Nanjing (CN)

(72) Inventors: Zhusheng Nie, Nanjing (CN); Jianyu Tie, Nanjing (CN); Jianpeng Guo, Nanjing (CN)

(21) Appl. No.: 19/556,184

(22) Filed: Mar. 4, 2026

Related U.S. Application Data
(63) Continuation of application No. PCT/CN2025/074276, filed on Jan. 23, 2025.

(51) Int. Cl. H01M 50/256; A01G 20/47; A45F 3/08; H01M 50/227; H01M 50/247; H01M 50/262

(52) U.S. Cl. CPC H01M 50/256; A01G 20/47; A45F 3/08; H01M 50/227; H01M 50/247; H01M 50/262; H01M 2220/30

(57) ABSTRACT

A housing for an electrical device has a battery pack interface for connecting with a battery pack. The housing includes at least a first component made of a first material. The first material includes polypropylene beads that are expanded and molded together. A ratio of a volume of the first component to a volume of the housing is greater than or equal to 50% and less than or equal to 90%. The housing also includes a plurality of second components. At least part of the first component is arranged between two second components of the plurality of second components.

### RELATED APPLICATION INFORMATION

This application is a continuation of International Application Number PCT/CN2025/074276, filed on Jan. 23, 2025, which application is incorporated herein by reference in its entireties.

### BACKGROUND

A backpack power tool, such as the backpack blower, always has a battery pack interface to mount with a battery module carried on the back of a worker. The battery module carried on the back of the worker is expected to have a large capacity so as to provide sufficient power to the backpack power tool for prolonged use. Long periods of carrying of the battery module on the worker's back will cause the user's fatigue.

This part provides background information related to the present application, and the background information is not necessarily the existing art.

### SUMMARY

An electrical device includes a housing comprising a battery pack interface for connecting with a battery pack. The housing includes at least a first component made of a first material, the first material includes polypropylene beads that are expanded and molded together, and a ratio of a volume of the first component to a volume of the housing is greater than or equal to 50% and less than or equal to 90%.

In some examples, the first component includes a handle.

In some examples, the housing includes a plurality of second components made of a second material, and the first component is arranged between two second components of the plurality of second components.

In some examples, one of the two second components is the battery pack interface.

In some examples, the polypropylene beads has a density of greater than or equal to 900 kg/m³ and less than or equal to 1100 kg/m³ before expansion.

In some examples, the polypropylene beads has a density of greater than or equal to 80 kg/m³ and less than or equal to 100 kg/m³ after expansion.

In some examples, the polypropylene beads has a density of greater than or equal to 50 kg/m³ and less than or equal to 200 kg/m³ after expansion.

In some examples, the polypropylene beads has a density of greater than or equal to 70 kg/m³ and less than or equal to 150 kg/m³ after expansion.

In some examples, the polypropylene beads has a density of greater than or equal to 80 kg/m³ and less than or equal to 120 kg/m³ after expansion.

In some examples, the polypropylene beads has an expansion ratio ranging from 5 to 20.

In some examples, the polypropylene beads has an expansion ratio ranging from 8 to 15.

In some examples, the polypropylene beads has an expansion ratio ranging from 9 to 13.

In some examples, the electrical device is a power tool.

In some examples, the electrical device is a battery pack backpack.

In some examples, the electrical device is a backpack blower.

In some examples, a weight of the battery pack backpack is less than or equal to 500 g.

In some examples, one of the two second components is a screw module.

In some examples, the screw module has a support structure that supports a hole to fix a screw and is embeddable to the first component

An electrical device includes a housing including a battery pack interface for connecting with a battery pack, the housing includes at least a first component made of a first material and a plurality of second components made of a second material, and at least part of the first component is arranged between two second components of the plurality of second components.

In some examples, the electrical device is a power tool.

In some examples, the electrical device is a battery pack backpack.

In some examples, a density of the first component is greater than or equal to 80 kg/m³ and less than or equal to 100 kg/m³ after expansion.

In some examples, the second component includes at least one hole to fix a screw.

In some examples, one of the two second components is the battery pack interface.

In some examples, one of the two second components is a screw module.

In some examples, the screw module has a support structure that supports a hole to fix a screw and is embeddable to the first component.

A battery pack includes a housing connectable to and supportable by a power tool, a plurality of battery cells supported within the housing, and a terminal assembly electrically connected with the plurality of battery cells for transferring electricity between the battery pack and the power tool. A ratio of a total weight of the plurality of battery cells to a weight of the housing is greater than or equal to 6:1 and less than or equal to 12:1.

In some examples, the housing includes at least a first component made of a first material, wherein the first material has a density greater than or equal to 50 kg/m³ and less than or equal to 200 kg/m³.

In some examples, the first material includes expanded polypropylene beads having an expansion ratio ranging from 5 to 20.

In some examples, the housing further includes a plurality of second components made of a second material.

In some examples, the plurality of second components includes a power tool interface.

In some examples, the plurality of second components includes a screw module.

In some examples, the first component is arranged between the power tool interface and the screw module.

### BRIEF DESCRIPTION OF THE DRAWINGS

FIG. 1 is an overall view of a battery pack backpack.

FIG. 2 is an exploded view of the example in FIG. 1.

FIG. 3 is another exploded view of the example in FIG. 1.

FIG. 4 is a rear view of the example in FIG. 1.

FIG. 5 is a section view of section A-A in FIG. 1.

FIG. 6 is an enlarged view of view B in FIG. 5.

FIG. 7 is a partial enlarged view of FIG. 3.

FIG. 8 is a partial enlarged view of FIG. 2.

FIG. 9 is an overall view of a backpack blower.

FIG. 10 is an overall view of a chainsaw.

FIG. 11 is an exploded view of the example in FIG. 10.

FIG. 12 is an overall view of a battery pack.

FIG. 13 is an overall view of the battery pack in FIG. 12.

FIG. 14 is an exploded view of the battery pack in FIG. 12.

FIG. 15 is a section view of the battery pack in FIG. 12.

FIG. 16 is an overall view of a screw module.

FIG. 17 is a section view of the screw module in FIG. 16.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In some examples, an electrical device could be a wide range of power tools that are actuated by an additional power source and mechanism for housework tasks such as cooking, cleaning, and around the house for purposes of driving, drilling, cutting, shaping, sanding, grinding, routing, polishing, painting, metalworking, woodworking, heating and more. The power tool could be a driver drill, an impact wrench, a right-angle drill, a reciprocating saw, a circular saw, a band saw, a table saw, a chainsaw, a work light, a rotary hammer, a nail gun, a leaf blower, a vacuum blower, a lawn mower, a snow thrower and the like. In some examples, the electrical device could be a battery charger configured for charging a battery pack. In some examples, the electrical device could be battery pack backpack or a battery pack as described below.

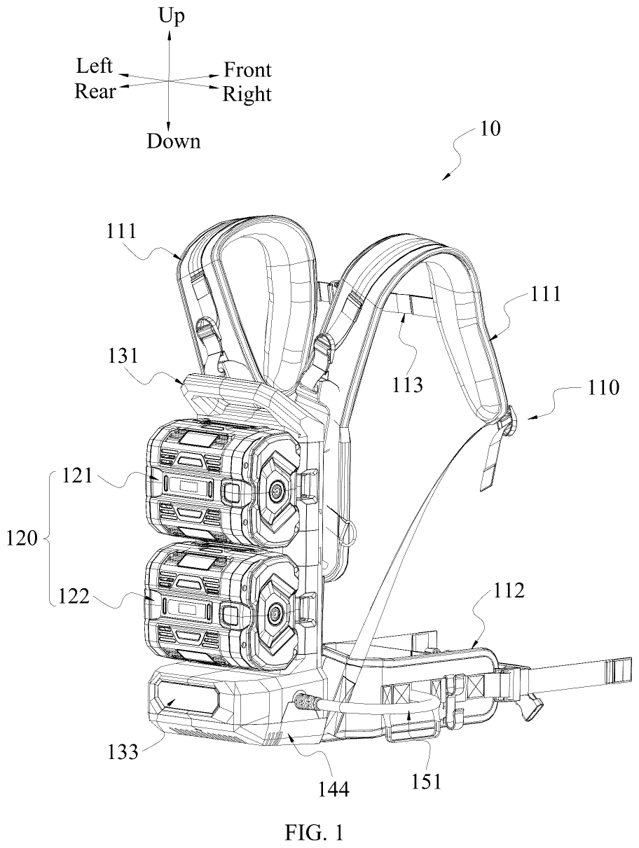

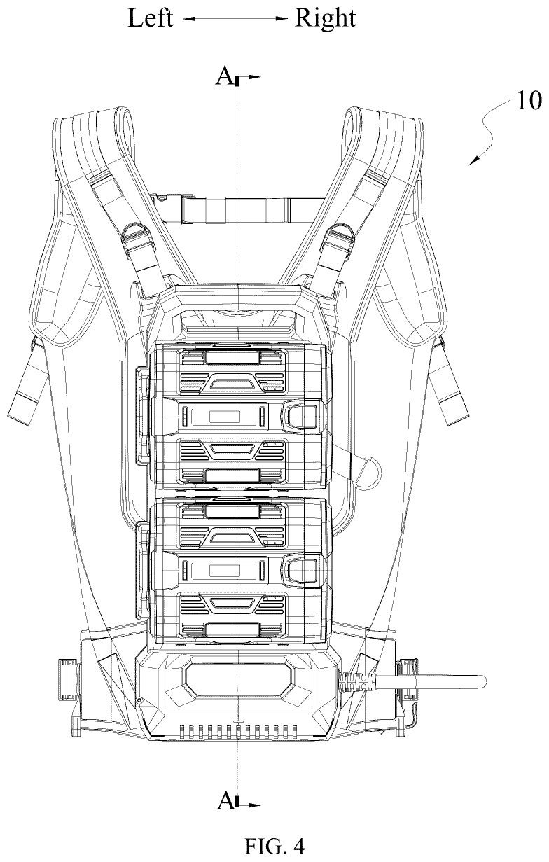

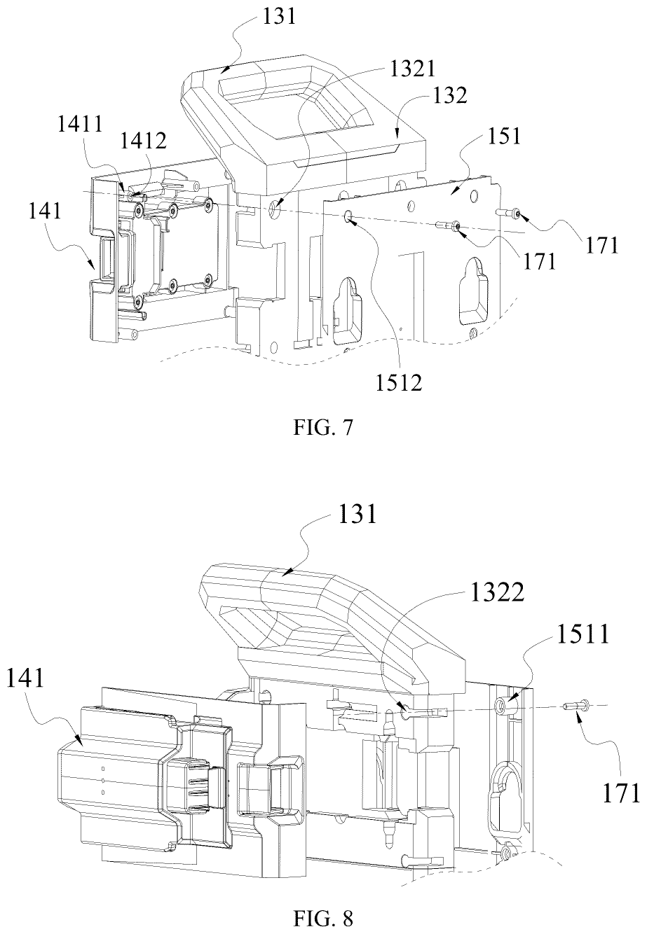

Referring to FIGS. 1-8, the electrical device is a battery pack backpack 10 and is illustrated and described in details. The battery pack backpack 10 can also be called a shouldering type power supply device. To use the battery pack backpack 10, at least one battery pack can be carried by a worker by wearing the battery pack backpack 10 on his/her back. In this way, the battery pack with large capacity could be utilized to provide a power source to other tools needed to be powered for a longtime or for heavy work, for example used in gardens. It could be understood that, the electrical device 10 could not only be attached on the back of the worker, but can also be attached on other body parts like one of the legs.

As shown in FIGS. 1-3, the battery pack backpack 10 includes a belt assembly 110, a battery module 120 and a housing 160.

The battery module 120 includes at least one battery pack to provide power to a power needed device such as the power tool discussed above. The battery module 120 could include only one battery pack 121, or more battery packs. In the present example, the battery module 120 includes a first battery pack 121 and a second battery back 122. The first battery pack 121 and the second battery back 122 are arranged in an up-and down manner. The first battery pack 121 is disposed above the second battery back 122, and two battery packs are basically aligned in an up-and down direction. It could be understood that the battery packs of the battery module 120 could also arranged in a left-and-right manner, and the edge of the battery packs may not need to be aligned. In the present example, the insertion direction of the first battery pack 121 and the second battery back 122 are both in the left-and-right direction. It could be understood that the insertion direction of each of the battery packs of the battery module 120 could be of different insertion direction.

Each of the battery packs of the battery module 120 can also have any nominal voltage. In some examples, the battery pack 121 can have a nominal voltage of approximately 10 V. In some examples, the battery pack 121 can have a nominal voltage up to approximately 80 V. For example, each of the battery packs of the battery module 120 can have a nominal voltage of approximately 12 V, 18 V, 20 V, 24 V, 32 V, 36 V, 48 V, 56 V, 60 V, etc. Each of the battery packs of the battery module 120 can supply an average discharge current that is equal to or greater than approximately 10 A, 15 A, 20 A or 25 A. Each of the battery packs of the battery module 120 can have ampere-hour capacity of greater than or equal to 1.5 Ah, 2 Ah, 2.5 Ah, 3 Ah, 3.5 Ah, 4 Ah, 4.5 Ah, 5 Ah, 5.5 Ah or 6 Ah. It could be understood that the battery module 120 could include a plurality of battery packs each having small ampere-hour capacity. The battery module 120 could also include one or two battery packs each having large ampere-hour capacity.

The belt assembly 110 is configured to attach the battery module 120 on the worker. In the present example, the belt assembly 110 includes two shoulder belts 111, a waist belt 112 and a shoulder strengthen belt 113. Two shoulder belts 111 are configured to attach to a left shoulder and a right shoulder of the worker. The shoulder strengthen belt 113 will share the pressure applied on the shoulder onto a chest of the worker. And the waist belt 112 will share the pressure applied on the shoulder into a waist of the worker. The belt assembly 110 also includes a connection body 114 to connect two shoulder belts 111 and the waist belt 112. The connection body 114 is attached to and fixed with the housing 160 which carries the battery module 120.

The housing 160 includes a battery pack interface 140 for connecting with a battery pack. The housing 160 is configured between the battery pack interface 140 and the belt assembly 110. The battery module 120 is attached to the belt assembly 110 through the housing 160.

In the present example, the battery pack interface 140 includes a first battery pack interface 141 for connecting with a first battery pack 121, and a second battery pack interface 142 for connecting with a second battery pack 122. The housing 160 includes a first component 130 on which the battery pack interface 140 is mounted. The first component 130 is made of a first material, and the first material includes polypropylene beads that are expanded and molded together. The polypropylene beads are always of a diameter of 2-7 mm before expansion. Polypropylene is of higher hardness and is more heat-resistant compared with some types of polyolefin such as polyethylene. In other words, the first component 130 is made of a foamed polyethylene plate which has low density but high hardness, so that housing 160 is designed to be hard but light.

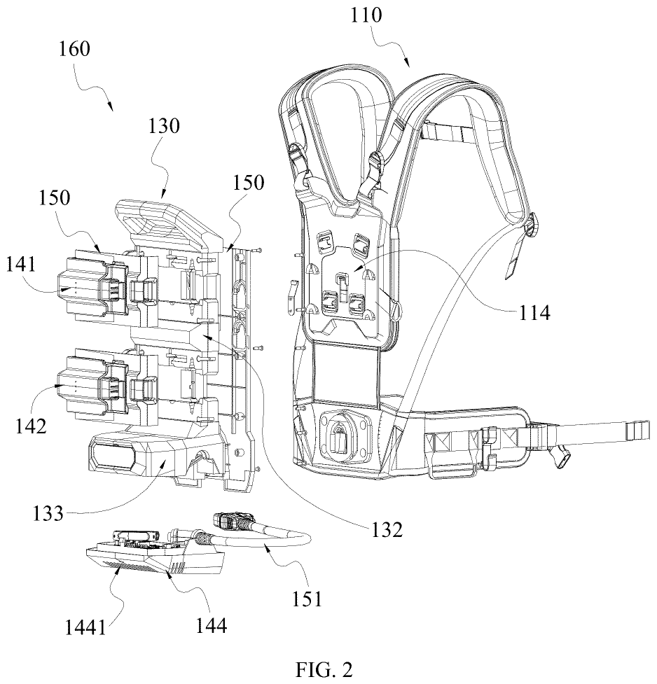

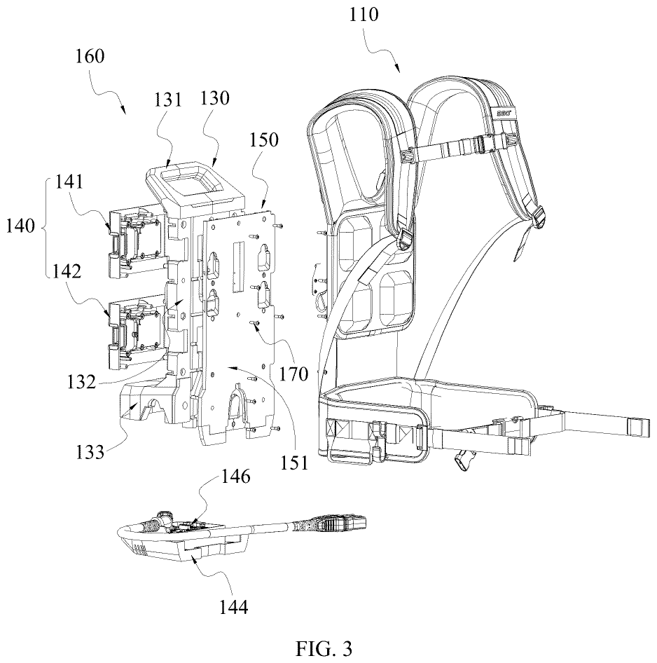

As shown in FIGS. 2-3, the housing 160 also includes a second component 150.

In the present example, the housing 160 includes a plurality of second components 150 made of a second material. At least part of the first component 130 is arranged between two second components 150 of the plurality of second components 150, and one of the two second components 150 is the battery pack interface 140. In this example, both of the first battery pack interface 141 and the second battery pack interface 142 could be the two second component 150, and the second component 150 include a supporting board 151 (see FIG. 3) and a battery pack interface 140.

In this example, the second component 150 is made of PC/ABS, a thermoplastic alloy of polycarbonate (PC) and acrylonitrile-butadiene-styrene (ABS). In other words, the second material could be the PC/ABS. The second component 150 here includes the battery pack interface 140 and the supporting board 151.

In some other examples, the housing 160 may include a third components made of a third material. The third components could be the second battery pack interface 142. The third components could also be the supporting board 151, so that the first component 130 is arranged between the second component 150 and the third component. It should be noted that the first material, the second material and the third material are three different materials.

The first material has a density greater than or equal to 50 kg/m³ and less than or equal to 200 kg/m³. The polypropylene beads has a density of greater than or equal to 900 kg/m³ and less than or equal to 1100 kg/m³ before expansion. In some example, the polypropylene beads has a density of greater than or equal to 50 kg/m³ and less than or equal to 200 kg/m³ after expansion. In some examples, the polypropylene beads has a density of greater than or equal to 70 kg/m³ and less than or equal to 150 kg/m³ after expansion. In some examples, the polypropylene beads has a density of greater than or equal to 80 kg/m³ and less than or equal to 130 kg/m³ after expansion. In some examples, a density of the first component 130 is greater than or equal to 80 kg/m³ and less than or equal to 100 kg/m³, for example, 85 kg/m³, 90 kg/m³ and 95 kg/m³. In the present example, The polypropylene beads has a density of approximately 1000kg/m³ before expansion, and a density of approximately 90 kg/m³ after expansion.

In some examples, the polypropylene beads has an expansion ratio ranging from 5 to 20. In some examples, the polypropylene beads has an expansion ratio ranging from 8 to 15. In some examples, the polypropylene beads has an expansion ratio ranging from 9 to 13. In one example, the polypropylene beads is foamed at a 10-fold expansion ratio. In one example, the polypropylene beads is foamed at a 10.5-fold expansion ratio. In one example, the polypropylene beads is foamed at an 11-fold expansion ratio. In one example, the polypropylene beads is foamed at an 11.5-fold expansion ratio. In one example, the polypropylene beads is foamed at a 12-fold expansion ratio.

Continuing the present example, the first component 130 is arranged between two second components 150 of the plurality of second components 150. To be more specific, the first component 130 is in middle of the battery pack interface 140 and the supporting board 151, and the battery pack interface 140 and the supporting board 151 are both of the second material. The supporting board 151 is directly connected and mated with the connection body 114 of the belt assembly 110. A plurality of fasteners 170 are utilized to assemble the battery pack interface 140, the first component 130 and the second component 150 altogether. The plurality of fasteners 170 here could be screws 171.

The housing 160 includes a handle 131. The handle 131 is a configured for the worker to hold, so that the battery pack backpack 10 could be lifted and removed to a different location. In the present example, the handle 131 is a part of the first component 130. The first component 130 also includes a base portion 133 on a bottom side of the first component 130 and a transition portion 132 connecting the handle 131 and the base portion 133. That is to say, the first material forms the handle 131, the transition portion 132 and the base portion 133. The handle 131, the transition portion 132 and the base portion 133 are one-piece molded together by the first material.

As shown in FIGS. 2, 3 &5, the battery pack backpack 10 includes a printed circuit board assembly 146. In the present example, the printed circuit board assembly 146 is disposed below the battery pack interface 140. Or say the printed circuit board assembly 146 is disposed below the battery module 120. The housing 160 includes a base cover 144 which is mated with the base portion 133, and the base portion 133 and the base cover 144 forms an accommodation space 145 for the printed circuit board assembly 146. It could be understood that an electrical cable 147 and other electric members can also be disposed in the accommodation space 145. The base cover 144 has a plurality of cooling openings 1441 for heat dissipation.

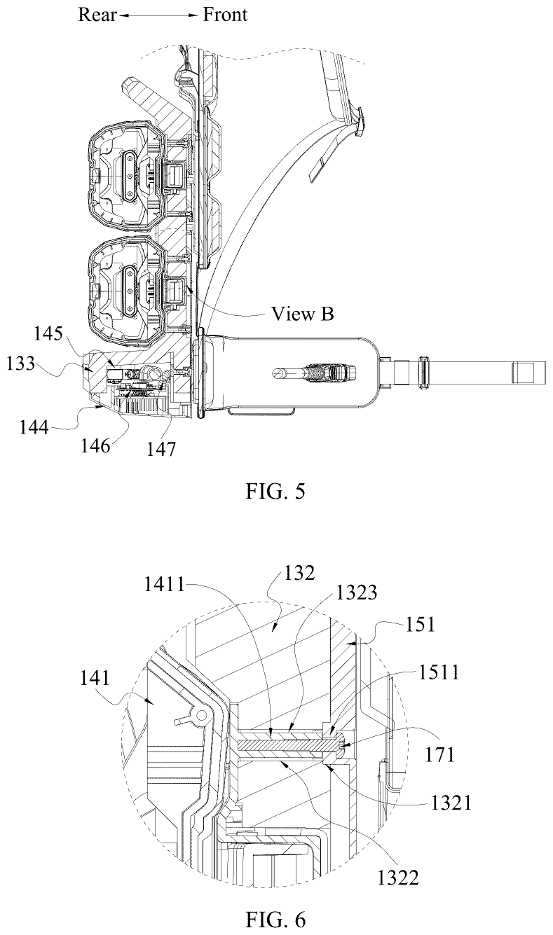

FIGS. 5-8 further illustrates the mounting manner of the housing 160, and shows how the first battery pack interface 141, the first component 130 and the supporting board 151 are mounted with each other.

The first battery pack interface 141 has a first protrusion 1411 formed on a front side of the first battery pack interface 141. A screw hole is formed inside the first protrusion 1411 and configured to mate with external threads of screw 171. The supporting board 151 has a second protrusion 1511 that is configured to mate with the first component 130. The transition portion 132 has a through hole 1323 that is configured to mate with the first protrusion 1411 and screw 171. The through hole 1323 includes a first opening 1321 located on a rear side and a second opening 1322 located on a front side. The first opening 1321 connects to the second opening 1322, and the first opening 1321 and the second opening 1322 form the through hole 1323 for the screw 171 to pass through. The first opening 1321 is configured to mate with the first protrusion 1411, and the second opening 1322 is configured to mate with the second protrusion 1511. In this way, the first battery pack interface 141, the first component 130 and the supporting board 151 form a sandwich structure, and the first component 130 is positioned in middle of the sandwich structure.

With the use of the first material of a polypropylene foam, a ratio of a volume of the first component 130 to a volume of the housing 160 is greater than or equal to 50% and less than or equal to 90%. In some examples, the ratio of a volume of the first component 130 to a volume of the housing 160 is greater than or equal to 60% and less than or equal to 90%. In some examples, the ratio could be approximately 65%, 70%, 75%, 80% and 85%. In the present example, a ratio of the volume of the polypropylene foam to a volume of the PC/ABS is approximately 6 to 1.

In the example of the battery pack backpack 10, a weight of the battery pack backpack 10 is less than or equal to 500 g. To define the weight of the battery pack backpack 10, the battery module 120 is not included. In other words, the battery pack backpack 10 consists of the battery pack interface 140, the housing 160 and the belt assembly 110.

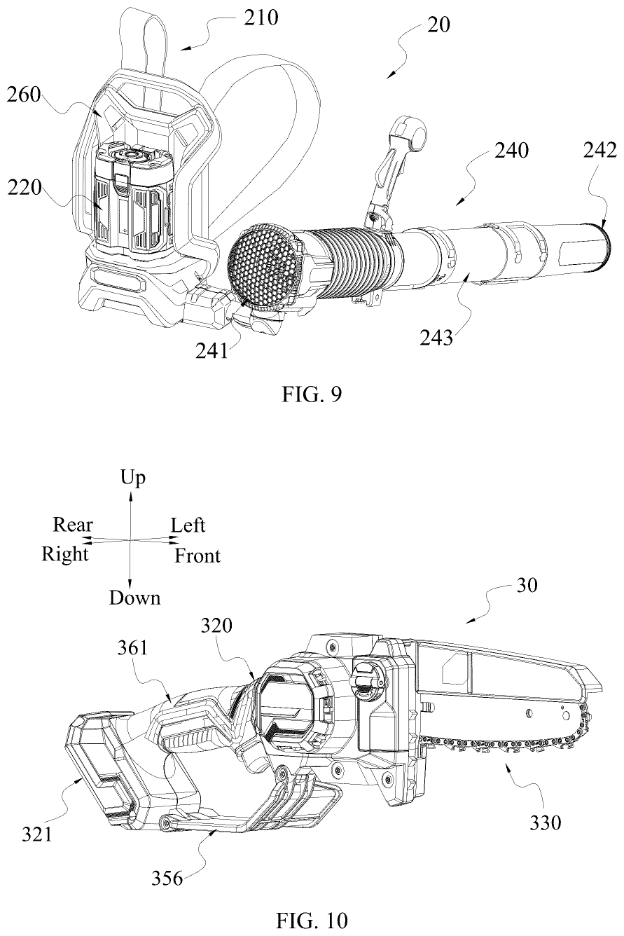

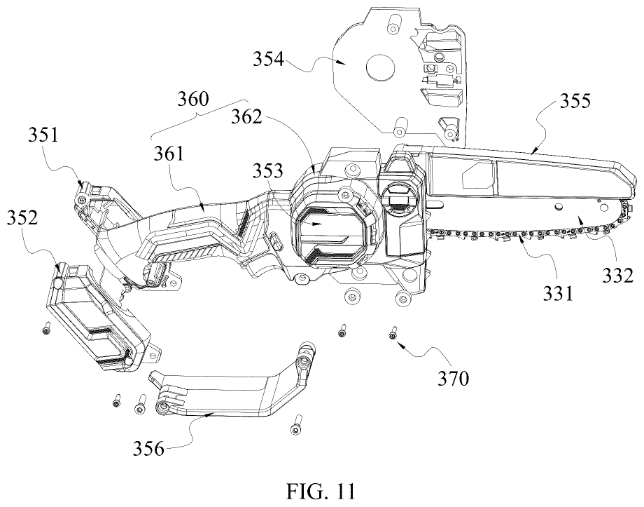

As shown in FIG. 9, the electrical device could be a backpack power tool 20. The backpack power tool 20 includes a belt assembly 210, a battery module 220 and a housing 260. The housing 260 could be configured of the first component as shown in the electrical device 10. Detailed structures will not be repeated here. The backpack power tool 20 also includes an actuating assembly 240 to perform a certain kind of work. The actuating assembly 240 in this example includes an air inlet 241 for air to pass in, an air outlet 242 for air to pass out, and an air tube 243 for air to pass through. Besides, an electrical motor and a fan are also located inside the air tube 243. The electrical motor drives the fan to rotate, so that the air could be sucked inside the air inlet 241.

The battery pack backpack 10 illustrated in FIGS. 1-8 can be a portion of the backpack power tool 20. In other words, the technique solutions described above can also be used in the backpack power tool 20. In some examples, the backpack power tool 20 could be a backpack blower, a backpack vacuum or a backpack power tool system with at least a portion of the backpack power tool 20 being carried on the back of the worker. It is understandable that, in order to decrease the weight and increase the hardness of an electrical device, the first material and the construction of the first component and the second component can also be used in the electrical device which is not carried by the worker. For example, the electrical device could be a portable power station or a battery inverter that is placed on a platform or hanging on a rack.

The electrical device could be a power tool 30, for example, a handheld power tool. As shown in FIGS. 10 & 11, the power tool 30 is a chainsaw.

The power tool 30 includes a housing 320, a driving assembly and an actuating assembly 330. A handle 361 is formed in the housing 320 and is configured to be griped by the worker. The housing 320 forms a room for the driving assembly including an electrical motor and a gear box with gears inside. The actuating assembly 330 includes a saw chain 331 and a guide plate 332. The guide plate 332 is configured to support and guide the saw chain 331. An end of the guide plate 332 is supported by the housing 320 and extends out of the housing 320 along a front-rear direction. The electrical motor drives the saw chain 331 to rotate under the guidance of the guide plate 332 to implement a cutting function.

The housing 320 includes a battery pack interface 321 for connecting with a battery pack. The battery pack interface 321 includes a left interface 351 and a right interface 352. The housing 320 also includes a left cover 354 and a right cover 353. A hand protector 356 is located below the handle 361 and is configured to protect the worker's hand.

The housing 320 includes at least a first component 360 made of a first material, and the first material comprises polypropylene beads that are expanded and molded together. The first component 360 in this example extends from the battery pack interface 321 to the actuating assembly 330. In other words, the first component 360 includes the handle 361 and the main body 362. A protecting shield 355 is connected with the main body 362 and prevents the saw chain 331 from flying to the worker accidently. The housing 320 also includes a plurality of second components 350 made of a second material. The second components 350 include the left cover 354, the right cover 353, the left interface 351, the right interface 352 and the hand protector 356.

At least part of the first component 360 is arranged between two second components of the plurality of second components 350. In the present example, the handle 361 is disposed between the left interface 351 and the right interface 352, and the main body is disposed between the left cover 354 and the right cover 353. A plurality of fasteners 370, such as screws, are used to fix the housing 320. A ratio of a volume of the first component 360 to a volume of the housing 320 is greater than or equal to 50% and less than or equal to 90%. In the present example, a ratio of the volume of the polypropylene foam to a volume of the PC/ABS is approximately 5 to 1.

The characteristics and the construction manner of the first component 360 and the second component 350 of the power tool 30 can refer to those of the battery pack backpack 10, and will not be repeated here.

In one example, the electrical device could be a grass trimmer. The grass trimmer includes a handle for a worker to hold, a trimming head outputting a trimming work and a rod connecting the trimming head and the grip. The trimming head has a housing that forms an accommodation space and a trimming spring that can rotate and trim the grass. An electrical motor is spaced in the accommodation space. At least a portion of the grass trimmer could be made of the first material as described in the example of the battery pack backpack 10 above. The first material is a polypropylene foam expanded from polypropylene beads. The grass trimmer can also have an auxiliary handle disposed between the trimming head and the handle. The handle and the auxiliary handle could be made of the first material as described in the example of the battery pack backpack 10 above. The grass trimmer also has a battery pack interface to mount with a battery pack. The rod, the housing of the head and/or the battery pack interface could be made of the second material such as the PC/ABS as described in the example of the battery pack backpack 10 above. In the present example, a ratio of the volume of the polypropylene foam to a volume of the PC/ABS is approximately 2 to 1.

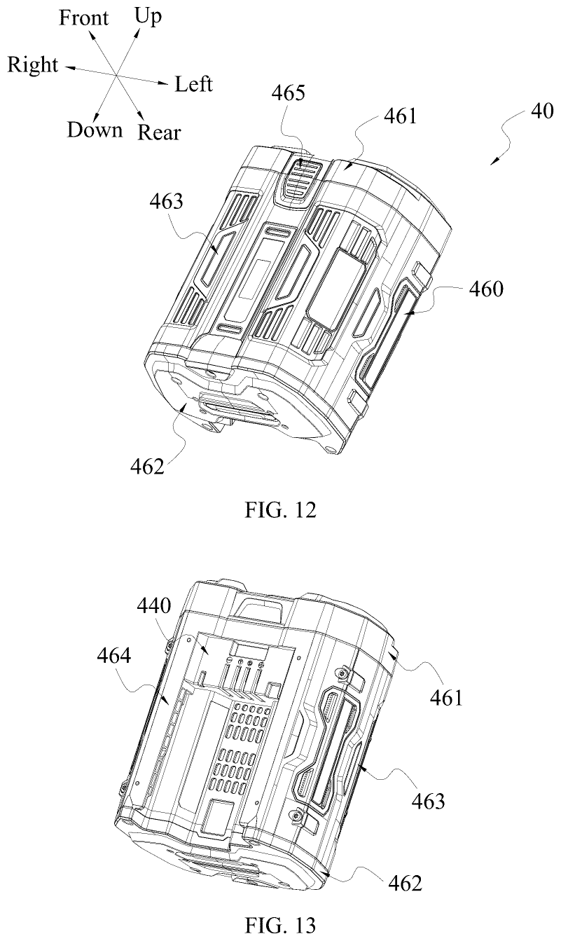

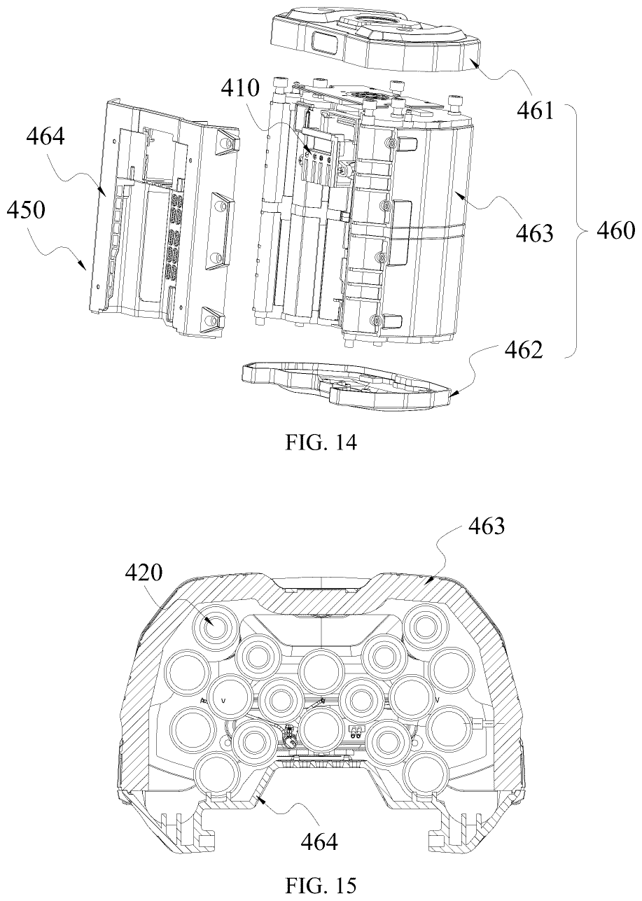

Now referring to FIGS. 12-15, a battery pack 40 is illustrated. The battery pack 40 can be configured for transferring power to and receiving power from one or more electrical devices, such as a power tool, a battery charger and the like. The battery pack 40 can power a wide range of power tools including a driver drill, an impact wrench, a right-angle drill, a reciprocating saw, a circular saw, a band saw, a table saw, a work light, a rotary hammer, a nail gun, a blower, a vacuum blower, a lawn mower, a snow thrower and the like.

The battery pack 40 includes a housing 460 connectable to and supportable by a power tool, a plurality of battery cells 420 supported within the housing 460, and a terminal assembly 410 electrically connected with the plurality of battery cells 460 for transferring electricity between the battery pack 40 and the power tool.

The housing 460 includes a top housing 461, a bottom housing 462, a front housing 463 and a rear housing 464. The top housing 461 and the bottom housing 462 are respectively located on a top side and a bottom side of the battery pack 40. The front housing 463 and the rear housing 464 are respectively located on a front side and a rear side of the battery pack 40. The terminal assembly 410 is mounted on the rear housing 464. The top housing 461, the bottom housing 462, the front housing 463 and the rear housing 464 form an accommodation space for the plurality of battery cells 420 and some electrical members such as a printed circuit board.

The battery pack 40 includes a first component 430 made of a first material and a plurality of second components 450 made of a second material. The first material includes polypropylene beads that are expanded and molded together, and the second material could be PC/ABS as described above. The plurality of second components 450 includes a power tool interface 440 through which to mount the battery pack 40 together the power tool.

The characteristics including the density, the expansion ratio, and the construction manner of the first component 430 and the second component 450 of the battery pack 30 can refer to those of the battery pack backpack 10 described above, and will not be repeated here.

In the present example, the first component 430 includes the top housing 461, the bottom housing 462 and the front housing 463. The plurality of second components 450 at least includes the rear housing 464 which will be assembled to the power tool or other external electrical device. It should be noted that the battery pack 40 could also include a third component made of a third material.

With the use of the first material of a polypropylene foam, a ratio of a total weight of the plurality of battery cells 420 to a weight of the housing 460 is greater than or equal to 6:1 and less than or equal to 12:1. In some examples, a ratio of a total weight of the plurality of battery cells 420 to a weight of the housing 460 is greater than or equal to 7:1 and less than or equal to 12:1. In some examples, a ratio of a total weight of the plurality of battery cells 420 to a weight of the housing 460 is greater than or equal to 9:1 and less than or equal to 11:1.

The battery pack 40 includes a screw module 480. The screw module 480 has a first portion 481 that includes a hole 4813 to fix a screw 471 and is embeddable to the first component 430. In one example, the screw module 480 could be made of the second material. At least part of the first component 430 is arranged between two second components 450 of the plurality of second components 450.

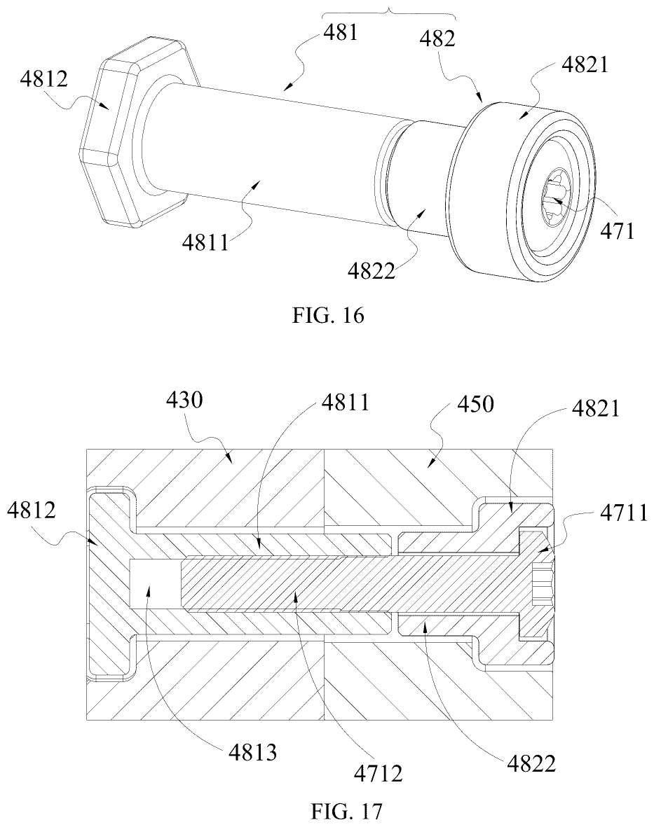

As shown in FIGS. 16 & 17, the screw module 480 includes a first portion 481 mated with the first component 430 and a second portion 482 mated with the second component 450. The screw 471 inserts into the second portion 482 and reaches first portion 481. The screw 471 has a screw head 4711 and a screw shaft 4712. The first portion 481 includes a mating end 4812 configured to be shape mated with the first component 430 and a screw threading end 4811 configured to receive the screw shaft 4712. The hole 4813 is inside the first portion 481. The second portion 482 includes a step head 4821 configured to support the screw head 4711 and a step end 4822 configured to allow the screw shaft 4712 to thread through. The screw threading end 4811 is inserted from the first component 430 into the second component 450.

In the present example, the mating end 4812 is in the shape of a hexagon. It is understandable that the mating end 4812 could be of any shape as long as it mates with the first component 430.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An electrical device, comprising:
a housing comprising a battery pack interface for connecting with a battery pack and at least a first component made of a first material comprised of polypropylene beads that are expanded and molded together wherein a ratio of a volume of the first component to a volume of the housing is greater than or equal to 50% and less than or equal to 90%.

2. The electrical device according to claim 1, wherein the first component comprises a handle.

3. The electrical device according to claim 1, wherein the housing comprises a plurality of second components made of a second material, and the first component is arranged between two second components of the plurality of second components.

4. The electrical device according to claim 3, wherein one of the two second components is the battery pack interface.

5. The electrical device according to claim 1, wherein the polypropylene beads has a density of greater than or equal to 900 kg/m³ and less than or equal to 1100 kg/m³ before expansion.

6. The electrical device according to claim 1, wherein the polypropylene beads has a density of greater than or equal to 80 kg/m³ and less than or equal to 100 kg/m³ after expansion.

7. The electrical device according to claim 1, wherein the polypropylene beads has an expansion ratio ranging from 5 to 20.

8. The electrical device according to claim 1, wherein the polypropylene beads has an expansion ratio ranging from 8 to 15.

9. The electrical device according to claim 1, wherein the polypropylene beads has an expansion ratio ranging from 9 to 13.

10. The electrical device according to claim 1, wherein the electrical device is a power tool.

11. The electrical device according to claim 1, wherein the electrical device is a battery pack backpack.

12. The electrical device according to claim 1, wherein the electrical device is a backpack blower.

13. The electrical device according to claim 11, wherein a weight of the battery pack backpack is less than or equal to 500 g.

14. The electrical device according to claim 4, wherein one of the two second components is a screw module.

15. The electrical device according to claim 14, wherein the screw module has a support structure having a hole to fix a screw and is embeddable in the first component.

16. A battery pack backpack, comprising:
a housing comprising a battery pack interface for connecting with a battery pack, at least a first component made of a first material, and a plurality of second components made of a second material, wherein at least a part of the first component is arranged between two second components of the plurality of second components.

17. A battery pack, comprising:
a housing connectable to and supportable by a power tool;
a plurality of battery cells supported within the housing; and
a terminal assembly electrically connected with the plurality of battery cells for transferring electricity between the battery pack and the power tool;
wherein a ratio of a total weight of the plurality of battery cells to a weight of the housing is greater than or equal to 6:1 and less than or equal to 12:1.

18. The battery pack of claim 17, wherein the housing comprises at least a first component made of a first material and the first material has a density greater than or equal to 50 kg/m³ and less than or equal to 200 kg/m³.

19. The battery pack of claim 18, wherein the first material comprises expanded polypropylene beads having an expansion ratio ranging from 5 to 20.

20. The battery pack of claim 18, wherein the housing further comprises a plurality of second components made of a second material.

21. The battery pack of claim 20, wherein the plurality of second components comprises a power tool interface and a screw module, and the first component is arranged between the power tool interface and the screw module.
